(19) United States
(12) Patent Application Publication
(10) Pub. No.: US 2011/0178673 A1
(43) Pub. Date: Jul. 21, 2011

(54) WEIGHT DETECTION DEVICE FOR VEHICLE AND METHOD FOR DETECTING WEIGHT OF VEHICLE COMPONENT

(75) Inventors: Tsutomu Nakamura, Kariya-city (JP); Kenji Takeda, Okazaki-city (JP); Yasuyuki Itoh, Ichinomiya-city (JP)

(73) Assignees: DENSO CORPORATION, Kariya-city (JP); NIPPON SOKEN, INC., Nishio-city (JP)

(21) Appl. No.: 12/972,872

(22) Filed: Dec. 20, 2010

(30) Foreign Application Priority Data
Jan. 20, 2010 (JP) 2010-10000

(51) Int. Cl. G06F 19/00

(52) U.S. Cl. 701/29

(57) ABSTRACT

A vehicle includes a wheel and a vehicle body connected with each other via a suspension having a spring. An oscillation detection unit detects an oscillation of the vehicle body in forward and backward directions. A resonance frequency detection unit detects a resonance frequency of the vehicle body according to a detection result of the oscillation detection unit. A weight determination unit determines a weight of the vehicle body according to the resonance frequency detected by the resonance frequency detection unit.

### CROSS REFERENCE TO RELATED APPLICATIONS

This application is based on and incorporates herein by reference Japanese Patent Application No. 2010-10000 filed on Jan. 20, 2010.

### FIELD OF THE INVENTION

The present invention relates to a weight detection device for a vehicle. In particular, the present invention may relate to a weight detection device for detecting a weight of a vehicle body of a vehicle, such as a passenger car, a track, or the like, having a wheel and the vehicle body connected with each other via a suspension including a spring. The present invention relates to a method for detecting a weight of the vehicle body of the vehicle.

### BACKGROUND OF THE INVENTION

In recent years, vehicles (automobiles), such as passenger cars and tracks, are equipped with vehicle evaluation systems (ecological-drive systems) in order to reduce fuel consumption to promote economical traveling and in order to reduce exhaust gas, such as CO2, NOx, SOx, and the like. Such an evaluation system, for example, is configured to detect a state of a vehicle by using various kinds of in-vehicle sensors, output assist information from a viewpoint of an economical traveling, and indicate fuel consumption. It is noted that the weight of a vehicle body of a vehicle may change when the number of occupants changes or when a loaded baggage changes. Consequently, fuel consumption may also change due to change in the weight of a vehicle. Therefore, the weight of a vehicle body is also one subject to be detected by an in-vehicle sensor.

For example, JP-A-5-286323 discloses a weight detection device configured to detect a laden weight of a vehicle according to a detection result of vertical oscillation (suspended resonance frequency) caused in a vehicle body thereby to cause a suspension control device to switch a suspension characteristic automatically. The weight detection device will be described with reference to FIG. 6. A vehicle includes four wheels 1 and the vehicle body 2 connected with each other via suspensions 3. Each of the suspensions 3 includes, for example, a coil spring in order to mitigate vertical oscillation of each wheel. An acceleration sensor 4 is equipped in the vicinity of the suspension 3 for detecting oscillation (acceleration) of the vehicle body 2 in the vertical direction. The suspension control device is configured to determine a variation ΔG of the acceleration in a suspended resonance frequency region from the acceleration G detected by the acceleration sensor 4. The suspension control device is further configured to determine a variation ΔGL in a low frequency wave region and determine the vehicle weight according to a comparison result with a threshold. That is, the suspension control device determines whether the vehicle is in a full-load condition in this way.

However, such a weight detection device, which is configured to detect a weight of a vehicle body 2 according to a detection result of oscillation in the vertical direction of the vehicle body 2, has a following problem. When a vehicle travels, each suspension (spring) 3 receives various force due to unevenness of a road surface and the like. Consequently, each suspension 3 individually oscillates in the vertical direction. In addition, distribution of a weight in a vehicle occurs according to a loading position of an engine, a loading position of a baggage, and the like, and such a distribution of a weight causes deviation in a distribution of a load applied to each spring. Therefore, a detection result of the weight may vary in dependence upon a position of an acceleration sensor 4 equipped to the vehicle. Consequently, the weight may not be detected with sufficient accuracy. Furthermore, the vehicle body irregularly oscillates in the vertical direction when traveling on an uneven road surface and exerted with an influence of such unevenness. Therefore, it is necessary to execute a processing to remove such an influence. In consideration of this, multiple acceleration sensors 4 may be equipped to multiple positions of a vehicle, and detection signals of the acceleration sensors 4 may be averaged to enhance accuracy of the weight detection. However, in this case, the configuration of the weight device detection may be complicated, and production cost of the weight device detection may be increased due to increase in the acceleration sensors 4. The acceleration sensor 4 for detecting oscillation in the vertical direction may not be applied to another purpose. That is, such an acceleration sensor 4 for detecting vertical oscillation needs to be provided exclusively for the weight detection. In view of this, the production cost may also increase.

### SUMMARY OF THE INVENTION

In view of the foregoing and other problems, it is an object of the present invention to produce a weight detection device having a relatively simple structure, the weight detection device being configured to detect a weight of a vehicle body of a vehicle with enhanced accuracy. It is an object of the present invention to produce a method for detecting a weight of the vehicle body of the vehicle.

According to one aspect of the present invention, a weight detection device configured to detect a weight of a vehicle body of a vehicle, the vehicle including a wheel and the vehicle body connected with each other via a suspension having a spring, the weight detection device comprises an oscillation detection unit configured to detect an oscillation of the vehicle body in forward and backward directions. The weight detection device further comprises a resonance frequency detection unit configured to detect a resonance frequency of the vehicle body according to the oscillation detected by the oscillation detection unit. The weight detection device further comprises a weight determination unit configured to determine a weight of the vehicle body according to the resonance frequency detected by the resonance frequency detection unit.

According to another aspect of the present invention, a method for detecting a weight of a vehicle body of a vehicle, the vehicle including a wheel and a vehicle body connected with each other via a suspension having a spring, the method comprises detecting an oscillation of the vehicle body in forward and backward directions. The method further comprises detecting a resonance frequency of the vehicle body according to the detected oscillation. The method further comprises determining a weight of the vehicle body according to the detected resonance frequency.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a vehicle provided with a weight detection device according to one embodiment of the present invention;

FIG. 2 is a block diagram showing an information system of the vehicle;

FIG. 3 is a flow chart showing a weight detection processing for the vehicle;

FIG. 4A is a graph showing a relationship between a frequency of oscillation in forward and backward directions and an oscillation strength, and FIG. 4B is a graph showing a deviation in the frequency from a reference value when a loaded object exists in the vehicle;

FIG. 5 is a schematic view showing a vehicle provided with a weight detection device according to another embodiment of the present invention; and

FIG. 6 is a schematic view showing a vehicle provided with a weight detection device according to a prior art.

### DETAILED DESCRIPTION OF PREFERRED EMBODIMENTS

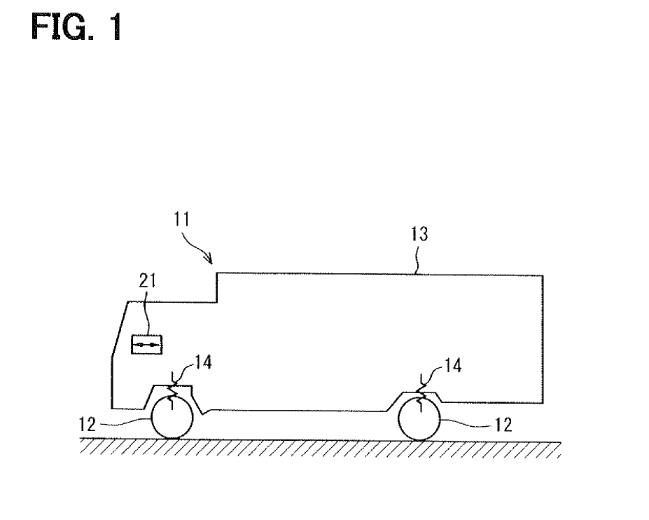

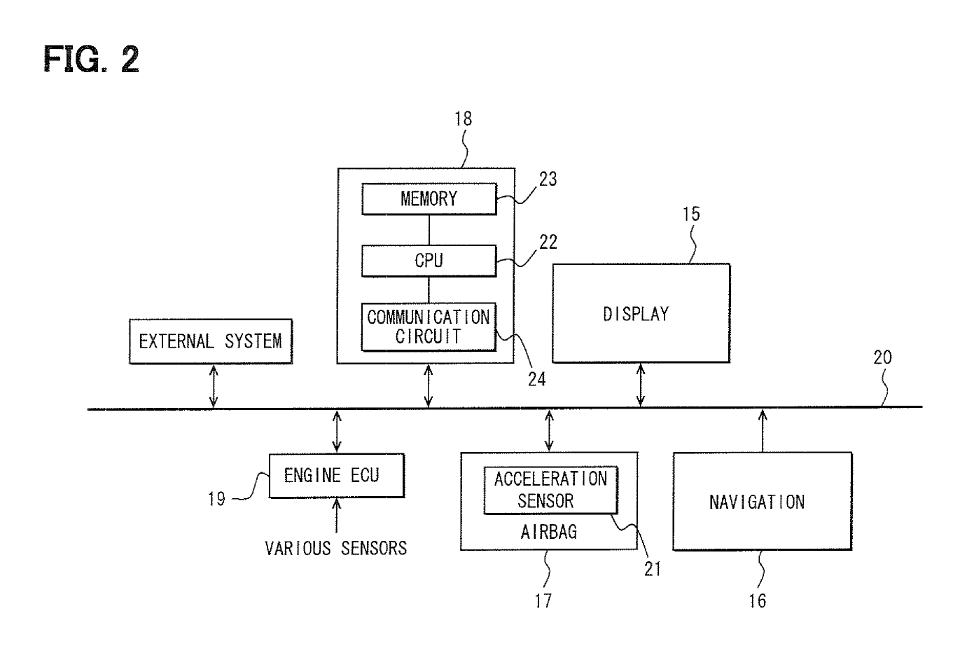

As follows, an embodiment of the present invention applied to a vehicle, such as a track or a van-type automobile, provided with an ecological-drive system will be described with reference to FIG. 1 to FIG. 4. FIG. 1 shows an overview of a vehicle (track) 11, and FIG. 2 shows a configuration of an information system of the vehicle 11. As shown in FIG. 1, the vehicle 11 includes four wheels 12 and a vehicle body 13, which are connected with each other and resiliently suspended via a suspension 14 including a spring device such as a coil spring. In FIG. 1, two of the four wheels 12 are shown. The vehicle body 13 is provided with a driver seat at the front portion and a loading platform at the rear portion (not specifically illustrated).

An instrument panel is provided to the front portion of the driver seat, and the instrument panel is provided with a meter unit and a steering wheel (not specifically illustrated). The center portion (center console portion) of the instrument panel is provided with a center display unit 15 (refer to FIG. 2). The center display unit 15 includes a display unit, such as a liquid crystal display device, a display control unit for controlling indication of the display unit, an operation unit including a touch panel and/or a mechanical key, an audio output unit, and the like. The display unit of the center display unit 15 is configured to indicate a navigation screen and various kinds of information such as evaluation information.

Further, as shown in FIG. 2, the inside of the instrument panel on the front side of the driver seat is provided with a generally-known car navigation system 16, an airbag system 17, an ecological-drive system ECU (control unit) 18, an engine ECU 19, and the like. The center display unit 15, the car navigation system 16, the airbag system 17, the control unit 18, and the engine ECU 19 are connected with another system via an in-vehicle network 20 such as a controller area network (CAN).

As generally known, the airbag system 17 is configured of an acceleration sensor 21 and an ignition device. The acceleration sensor 21 detects acceleration working on the vehicle body 13 in the forward and backward directions. The ignition device causes the air bag to expand when the acceleration sensor 21 detects collision (none shown). For example, a capacitance-type semiconductor acceleration sensor is employed as the acceleration sensor 21. The engine ECU 19 is configured to input signals from various sensors in the car and perform a realtime processing of the signals to generate data. For example, the various sensors may include an engine rotation speed sensor, an accelerator position sensor, a vehicle speed sensor, a shift position sensor, and the like.

The control unit 18 is one component of an ecological-drive system and includes a CPU (computer) 22, a memory card 23, and the like. The control unit 18 is connected with the in-vehicle network 20 via a communication circuit 24. The memory card 23 is removable relative to the control unit 18 and configured to function as a storage unit for storing a history of a traveling state of the vehicle 11.

The CPU 22 is configured to execute software to obtain various information representing the present traveling state of the vehicle 11 and evaluate the traveling state from a viewpoint of economical traveling such as a fuel-efficient travel or a small emission travel, according to its software configuration. The CPU 22 is further configured to cause the display unit of the center display unit 15 to indicate assist information, as needed, for advising an approach to an ideal economic traveling state. The evaluation may include evaluation of fuel consumption, evaluation of economical traveling, and the like. The assist information when economical traveling is not performed may include a way of operation of the engine rotation speed, the vehicle speed, the shift position, and the like. The evaluation information (assist information) may be indicated in various ways.

The CPU 22 inputs various information via the in-vehicle network 20 in order to obtain data of the present traveling state of the vehicle 11. The various information may include engine rotation speed information, accelerator position information, vehicle speed information, shift position information, travel distance information, time information, on/off information on an ignition device, and the like Further, the CPU 22 inputs a detection signal of the acceleration sensor 21 of the airbag system 17. The CPU 22 further obtains traffic information on the road, on which the vehicle travels, from the car navigation system 16 via the in-vehicle network 20.

As described above, the control unit 18 (CPU 22) evaluates the data of the present traveling state of the vehicle 11 from a viewpoint of economical traveling. The ideal economic traveling state differs in dependence upon difference in the number of occupants and difference in the weight of a baggage currently loaded on the loading platform of the vehicle 11. That is, the ideal economic traveling state differs in dependence upon fluctuation in the total weight of the vehicle body 13. Thus, the weight of the vehicle body 13 is one factor, which should be detected for evaluation of the traveling state of the vehicle 11.

Therefore, in the present embodiment, the control unit 18 causes the CPU 22 to execute a weight determination program having a software configuration to function as a weight detection device for determining (detecting) the weight of the vehicle body 13. The operation of the weight determination program will be described later in detail. The weight determination is performed by causing the acceleration sensor 21 to detect a change in the acceleration with time elapse, i.e., oscillation (movement with time elapse) of the vehicle body 13 in the forward and backward directions. Specifically, the weight determination is performed according to the following manner.

In general, the spring of the suspension 14, which resiliently suspends the vehicle body 13 of the vehicle 11, is configured to oscillate in the vertical direction. It is noted that, the spring of the suspension 14 has a spring component in the forward and backward directions to a certain extent. Therefore, the spring and the vehicle body 13 oscillate in the forward and backward directions when acceleration is applied to the vehicle body 13 in the forward and backward directions. The acceleration in the forward and backward directions is naturally caused with movement of the vehicle, such as start of the vehicle 11, acceleration of the vehicle 11, deceleration of the vehicle 11, and stop of the vehicle 11.

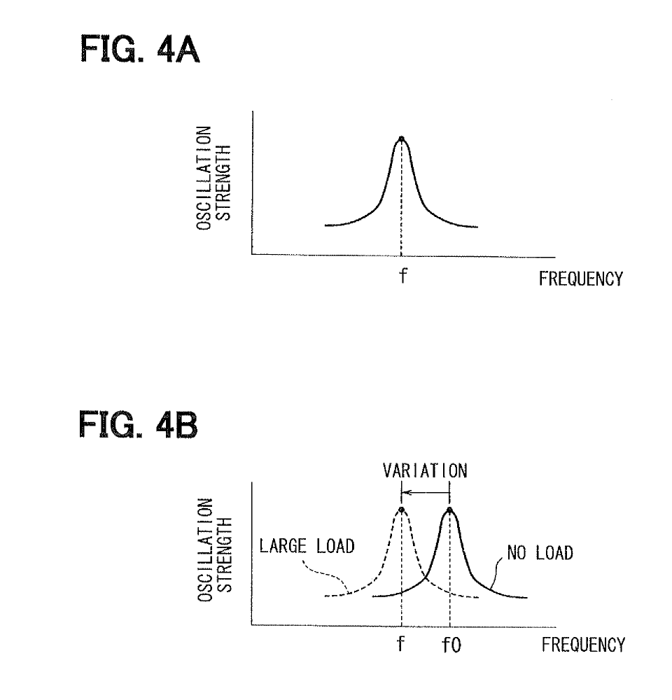

As shown in FIG. 4A, oscillation of the vehicle body 13 in the forward and backward directions shows a predetermined distribution between an oscillation strength (amplitude) and frequency. In the distribution, a peak of the oscillation strength appears at a resonance frequency f. The resonance frequency f has a specific value determined by the total weight of the vehicle body 13 and the spring constant of the suspension (spring) 14 in the forward and backward directions. That is, the resonance frequency f varies with variation (fluctuation) in the weight of the vehicle body 13. Therefore, the weight of the vehicle body 13 can be determined by detecting the resonance frequency f of oscillation in the forward and backward directions.

Specifically, the control unit 18 (CPU 22) first obtains a detection signal of the acceleration sensor 21 of the airbag system 17 for a specific time period until oscillation is attenuated to be ceased and stores a signal waveform of the detection signal in the time period. Subsequently, the control unit 18 (CPU 22) obtains a relationship between the oscillation frequency and the oscillation strength (amplitude) by fast Fourier transform and calculates the resonance frequency f. Thus, the control unit 18 (CPU 22) compares the obtained resonance frequency f with a reference resonance frequency f0 (refer to FIG. 4B) stored beforehand thereby to determine the weight of the vehicle body 13.

As described above, in the present embodiment, a forward and backward oscillation detection unit is configured to the control unit 18 (CPU 22), the acceleration sensor 21, and the like, and the control unit 18 (CPU 22) functions as a resonance frequency detection unit and a weight determination unit. In the present embodiment, the oscillation detection, i.e., acquisition of the detection signal of the acceleration sensor 21 is performed throughout a specific time period, such as 10 seconds, immediately after the vehicle 11 slows down and stops. Further, according to the present embodiment, the resonance frequency, in the state where the loaded object is not loaded in the loading platform of the vehicle body 13 and only one driver is an occupant of the vehicle, is obtained beforehand and stored as the reference resonance frequency f0 (refer to FIG. 4B). Further, the weight of the vehicle body 13 is determined in multiple steps according to the deviation of the resonance frequency f obtained during operation of the vehicle 11 from the reference resonance frequency f0.

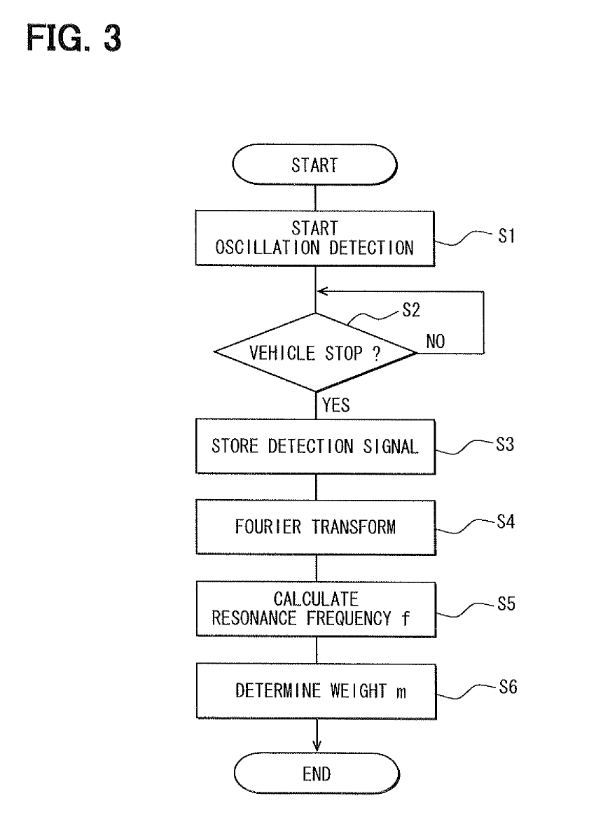

As follows, an operation of the weight detection device according to the present embodiment will be described with reference to FIG. 3, FIG. 4. The flow chart of FIG. 3 shows a procedure executed by the CPU 22 of the control unit 18 for the weight determination (weight detection) of the vehicle body 13. At step S1, oscillation detection of the vehicle body 13 in the forward and backward directions is started on activation of an ignition switch device of the vehicle. At step S2, it is determined whether the vehicle 11 slows down and stops. The present determination whether the vehicle 11 stops can be made according to, for example, the speed information obtained from the vehicle speed sensor.

When stop of the vehicle 11 is detected (Yes at step S2), the processing proceeds to S3. At step S3, the detection signal of the acceleration sensor 21 is obtained for 10 seconds, and the signal waveform of the acceleration sensor 21 is stored. In this way, oscillation of the vehicle body 13 in the forward and backward directions caused immediately after stop of the vehicle 11 is detected. Thus, the oscillation immediately after the vehicle 11 slows down and stops is detected thereby to enable the oscillation detection without influence of movement (acceleration and deceleration) of the vehicle 11. At subsequent step S4, processings such as Fourier transform is performed according to the stored signal waveform. At step S5, the resonance frequency f is demanded.

At step S6, the weight of the vehicle body 13 is determined according to the resonance frequency f. For example, a dynamic equation of a spring can be employed for determining the weight of the vehicle body 13 from the resonance frequency f. The weight of the vehicle body 13 can be computed from the following equations (1), (2) with the weight m of the vehicle body 13 and a spring constant k.

$$\begin{matrix}f = \frac{1}{2 π} \sqrt{\frac{k}{m}} & ( 1 ) \\ m = \frac{k}{{( 2 π f )}^{2}} & ( 2 )\end{matrix}$$

In order to obtain the absolute value of the weight m of the vehicle body 13, it is necessary to obtain the spring constant k beforehand using a known weight. Nevertheless, even when an accurate value of the spring constant k is not known, a relative variation in the weight m can be obtained from a relative variation in the resonance frequency f. Specifically, as shown in FIG. 4B, the reference resonance frequency f0 in the state where a baggage is not loaded on the vehicle body 13 is relatively large. As the weight of the vehicle body 13 (weight of a loaded baggage) becomes large, the value of the resonance frequency f becomes small gradually. Therefore, a quantity of a loaded baggage can be easily determined according to the variation in the detected resonance frequency f from the reference resonance frequency f0.

Thus, in consideration of the weight m of the vehicle body 13 obtained in the above-described manner, the control unit 18 (CPU 22) is configured to evaluate the traveling state, generate the assist information for economical traveling, and indicate the generated assist information. The processing of the weight detection may be performed each time when the vehicle 11 stops. Alternatively, the processing of the weight detection may be performed intermittently. Specifically, for example, the processing of the weight detection may be performed again when the vehicle 11 stops after elapse of a specific time periods, such as 30 minutes or 1 hour, from the previous weight detection. Alternatively, the processing of the weight detection may be performed on instruction of a user (driver).

As described above, according to the present embodiment, oscillation of the vehicle body 13 in the forward and backward directions is detected according to a detection signal of the acceleration sensor 21. Further, the weight of the vehicle body 13 is determined according to the detected resonance frequency f of the vehicle body 13. Dissimilarly to conventional oscillation detection in the vertical direction previously performed, the oscillation detection in the forward and backward directions is not exerted with influence of irregular and accidental oscillation resulting from unevenness of a road surface. In addition, the vehicle body 13 integrally moves totally in the forward and backward directions. Therefore, even when variation occurs in the load distribution applied to the spring of each of the suspensions 14, influence of such a variation can be revoked.

As a result, accuracy of the weight detection of the vehicle body 13 performed by the load detection device according to the present embodiment can be sufficiently enhanced, compared with a conventional device. In addition, detection result of the load detection device is substantially constant regardless of a position where the acceleration sensor 21 for oscillation detection is mounted to the vehicle body 13. In addition, the acceleration sensors 21 need not be placed at multiple positions. Therefore, the forward and backward oscillation detection unit (acceleration sensor 21) can be located at an arbitrary position. Thus, the structure of the load detection device can be simplified. In particular, according to the present embodiment, the acceleration sensor 21 originally provided to the airbag system 17 for collision detection is also used for the oscillation detection and the weight detection. Therefore, the total structure including the load detection device can be further simplified, and cost reduction can be promoted.

According to the present embodiment, the weight of the vehicle body 13 is determined according to the detected oscillation in the forward and backward directions in the state where oscillation certainly occurs in the forward and backward directions immediately after the vehicle 11 slows down and stops. Therefore, the resonance frequency f is steadily and correctly detectable, regardless of influence caused y acceleration and deceleration of the vehicle 11. Thus, accuracy of the weight determination can be further enhanced.

According to the present embodiment, in particular, the weight of the vehicle body 13 is determined according to the variation between the prestored reference resonance frequency f0 in the reference state where no baggage is loaded and the detected resonance frequency f. Therefore, variation in the weight of the vehicle body 13 from the reference state can be determined with sufficient accuracy. For example, the reference resonance frequency f0 may be updated at a suitable time point in response to a driver's operation of a switch device or the like. In this case, suitable weight determination can be regularly performed correspondingly to variation in a spring characteristic of the suspension 14 caused by aging.

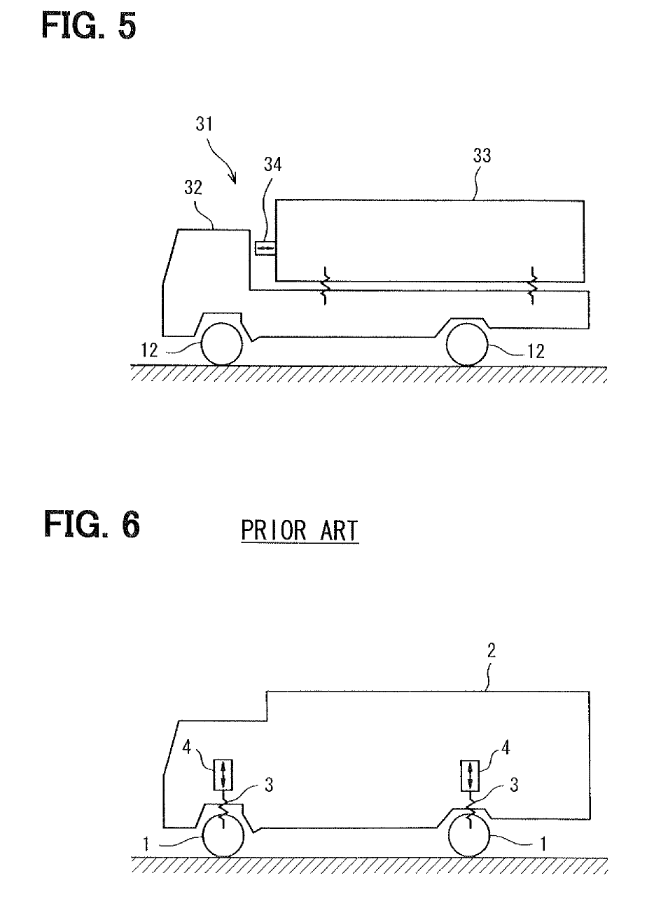

FIG. 5 shows another embodiment of the present invention. The present embodiment is different from the above-described embodiment in the following subjects. Specifically, a vehicle body 32 of a vehicle 31, such as a track, has an independent loading platform 33 and resiliently suspends the loading platform 33. An exclusive acceleration sensor (oscillation sensor, forward and backward oscillation detection unit) 34 detects oscillation of the loading platform 33 in the forward and backward directions.

According to the present configuration, the resonance frequency of the loading platform 33 of the vehicle body 32 is detectable according to the oscillation in the forward and backward directions detected by the acceleration sensor 34. Thus, the weight of the loading platform 33 can be determined from the detected resonance frequency. Therefore, according to the present embodiment, the weight of the loading-platform 33 of the vehicle body 32 can be also determined with high accuracy. In addition, the load detection device can be provided with a relatively simple structure.

In the above embodiment, the weight detection (weight determination) is performed by the control unit of the ecological-drive system equipped in the vehicle. Alternatively, the weight detection may be performed by another in-vehicle computer such as a computer of a car navigation system. The detected weight data may be utilized for various kinds of traveling controls, such as control of an active suspension, control of a brake device, in addition to the ecological-drive system. In the above embodiment, the reference resonance frequency f0 in the state where no baggage is loaded in the loading platform is employed. Alternatively, the weight determination may be performed by using the reference resonance frequency f0 in the state where a reference baggage having a known weight is loaded.

In the above embodiment, the acceleration sensor for the airbag system is also used as the forward and backward oscillation detection unit. It is noted that an exclusive acceleration sensor (oscillation sensor) may be provided for the forward and backward oscillation detection unit, in addition to an acceleration sensor for the airbag system. The oscillation sensor is not limited to a capacitance-type semiconductor sensor and may be a piezoelectric-type acceleration (oscillation) sensor. The above-described load detection device may be applied to another vehicle than a track or a van-type automobile.

Summarizing the above embodiments, in general, a spring of a suspension, which resiliently suspends a vehicle body of a vehicle, is configured to oscillate in the vertical direction. It is noted that, the spring of the suspension has a spring component in the forward and backward directions to a certain extent. Therefore, the spring and the vehicle body oscillate in the forward and backward directions when acceleration is applied to the vehicle body in the forward and backward directions. The acceleration in the forward and backward directions is naturally caused with movement of the vehicle, such as start of the vehicle, acceleration of the vehicle, deceleration of the vehicle, and stop of the vehicle. That is, a resonance frequency varies with variation (fluctuation) in the weight of the vehicle body. Therefore, the weight of the vehicle body can be determined by detecting the resonance frequency of oscillation in the forward and backward directions. The present inventors noticed such an oscillation in the forward and backward directions of the vehicle body and created the present invention.

Specifically, a weight detection device for a vehicle is configured to detect a weight of a vehicle body of a vehicle in which a wheel is connected with a vehicle body via a suspension having a spring. The weight detection device includes: a forward and backward oscillation detection unit configured to detect an oscillation in forward and backward directions of the vehicle body; a resonance frequency detection unit configured to detect a resonance frequency of the vehicle body according to a detection result of the forward and backward oscillation detection unit; and a weight determination unit configured to determine a weight of the vehicle body according to the resonance frequency detected by the resonance frequency detection unit.

According to the present configuration, the forward and backward oscillation detection unit detects oscillation of the vehicle body in the forward and backward directions, the resonance frequency detection unit detects the resonance frequency of the vehicle body from the detected oscillation in the forward and backward directions, and the weight determination unit determines the weight of the vehicle body according to the detected resonance frequency. Dissimilarly to oscillation detection in the vertical direction, the detection of oscillation in the forward and backward directions is not accompanied with irregular and accidental oscillation resulting from unevenness of a road surface. In addition, the entire vehicle body moves integrally in the forward and backward directions. Therefore, even when distribution of load applied to springs has a variation, oscillation and the weight of the vehicle body can be determined without influence of the variation.

As a result, detection accuracy of the weight detection device for detecting the weight of a vehicle body can be sufficiently enhanced. In addition, detection result of the load detection device is substantially constant regardless of a position where the forward and backward oscillation detection unit is mounted to the vehicle body. In addition, the sensors (forward and backward oscillation detection unit) need not be placed at multiple positions. Therefore, the forward and backward oscillation detection unit can be located at an arbitrary position. Thus, the structure of the load detection device can be simplified.

The weight determination unit may be further configured to detect the weight of the vehicle body according to oscillation detected by the forward and backward oscillation detection unit immediately after the vehicle slows down and stops.

At the time of acceleration or deceleration of the vehicle, oscillation in the forward and backward directions detected by the forward and backward oscillation detection unit is exerted with an influence of the acceleration or deceleration. On the contrary, immediately after the vehicle slows down and stops, oscillation certainly occurs in the forward and backward direction, regardless of such an influence caused by the acceleration or deceleration. Therefore, the forward and backward oscillation detection unit is enabled to detect oscillation at the time point. In addition, the resonance frequency is steadily and correctly detectable. Furthermore, accuracy of the weight determination by the weight determination unit can be further enhanced.

The weight determination unit may be further configured to store a reference resonance frequency corresponding to a reference weight of the vehicle beforehand. The weight determination unit may be further configured to determine the weight of the vehicle body according to a variation between the reference resonance frequency and the resonance frequency detected by the resonance frequency detection unit. In this way, variation from the reference state of the vehicle body weight can be determined with sufficient accuracy. In this case, the reference resonance frequency may be updated at a suitable time point. Thereby, suitable weight determination can be regularly made correspondingly to variation in the spring characteristic caused by aging or the like.

The forward and backward oscillation detection unit may be further configured to detect oscillation by utilizing a detection signal of an acceleration sensor equipped in the vehicle body for detecting collision or the like. In the present structure, the detection signal of the acceleration sensor for detecting collision (air bag control) can be also used for detection of oscillation in the forward and backward directions and detection of the weight of the vehicle body. Thus, the structure of the load detection device can be further simplified, and production cost thereof can be further reduced.

A vehicle having a vehicle body provided with a loading platform may include a sensor as the forward and backward oscillation detection unit for detecting oscillation of the loading platform in the forward and backward directions. In this way, detection of the weight of a loaded object can be performed with more sufficient accuracy in a vehicle, such as a track or a van type automobile, configured to load a baggage in a loading platform and convey the baggage.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A weight detection device configured to detect a weight of a vehicle body of a vehicle, the vehicle including a wheel and the vehicle body connected with each other via a suspension having a spring, the weight detection device comprising:
an oscillation detection unit configured to detect an oscillation of the vehicle body in forward and backward directions;
a resonance frequency detection unit configured to detect a resonance frequency of the vehicle body according to the oscillation detected by the oscillation detection unit; and
a weight determination unit configured to determine a weight of the vehicle body according to the resonance frequency detected by the resonance frequency detection unit.

2. The weight detection device according to claim 1, wherein the weight determination unit is further configured to determine the weight of the vehicle body according to the oscillation detected by the oscillation detection unit immediately after the vehicle slows down and stops.

3. The weight detection device according to claim 1, wherein the weight determination unit is further configured to:
store a reference resonance frequency corresponding to a reference weight of the vehicle beforehand; and
determine the weight of the vehicle body according to a variation between the reference resonance frequency and the resonance frequency detected by the resonance frequency detection unit.

4. The weight detection device according to claim 1, wherein the oscillation detection unit is further configured to detect the oscillation by utilizing a detection signal of an acceleration sensor equipped to the vehicle body for detecting collision.

5. The weight detection device according to claim 1, wherein
the vehicle body is equipped with a loading platform, and
the oscillation detection unit includes a sensor configured to detect an oscillation of the loading platform in the forward and backward directions.

6. A method for detecting a weight of a vehicle body of a vehicle, the vehicle including a wheel and a vehicle body connected with each other via a suspension having a spring, the method comprising:
detecting an oscillation of the vehicle body in forward and backward directions;
detecting a resonance frequency of the vehicle body according to the detected oscillation; and
determining a weight of the vehicle body according to the detected resonance frequency.

7. A computer readable medium comprising instructions executed by a computer, the instructions including the method according to claim 6.
